(19) United States
(12) Patent Application Publication
(10) Pub. No.: US 2010/0221996 A1
(43) Pub. Date: Sep. 2, 2010

(54) APPARATUS AND METHOD FOR RF PAM GAIN STATE CONTROL IN A MOBILE COMMUNICATION SYSTEM

(75) Inventors: Won-Jae KANG, Gyeonggi-do (KR); Su-Yang PARK, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/714,618

(22) Filed: Mar. 1, 2010

(30) Foreign Application Priority Data
Mar. 2, 2009 (KR) 10-2009-0017509

(51) Int. Cl. H04B 1/60

(52) U.S. Cl. 455/10

(57) ABSTRACT

An apparatus and a method for controlling a gain of a Radio Frequency Power Amplifier Module (RF PAM) in mobile communication system are provided. The method includes determining whether a temperature of the portable terminal is greater than a first threshold and whether a Received Signal Strength Indication (RSSI) value of the portable terminal is greater than a second threshold under a specific condition and selectively controlling the RF PAM gain state according to the determination outcome.

### CLAIM OF PRIORITY

This application claims the benefit under 35 U.S.C. §119(a) of a Korean patent application filed in the Korean Intellectual Property Office on Mar. 2, 2009 and assigned Serial No. 10-2009-0017509, the entire disclosure of which is hereby incorporated by reference.

### BACKGROUND OF THE INVENTION

1. Field of the Invention

The present invention relates to an apparatus and a method for controlling a gain output of a Radio Frequency Power Amplifier Module (RF PAM) according to a measured temperature and a detected Received Signal Strength Indication (RSSI) in a portable terminal having a thermister.

2. Description of the Related Art

Recently, multimedia related functions such as a Personal Media Player (PMP) function, a camera function, a video recording function, a video conferencing function are integrated into a portable terminal. As a result, a high power consumption is used due to these integrations which in turn reduces a battery life of the portable terminal. Further, the heat generated within the portable terminal is increased from these multi operations.

The portable terminal uses a thermister, which provides a measurement of temperature, in order to maintain a desired RF power based on digitized current temperature.

It is possible to compensate for the desired RF power when the thermister is used. However, when a received signal strength indicator (RSSI) is used to control the output level of a radio frequency power amplifier during an amplification of a modulated signal in its transmission circuit, it is not effective to use the thermister as the RF PAM gain state varies only based on the RSSI

Accordingly, a need exists for an apparatus and a method for a RF PAM gain state control in a mobile communication system.

### SUMMARY OF THE INVENTION

An aspect of the present invention is to solve at least the above-mentioned problems and/or disadvantages and to provide at least the advantages described below. Accordingly, an aspect of the present invention is to provide an apparatus and a method for a Radio Frequency Power Amplifier Module (RF PAM) gain state control in a mobile communication system.

Another aspect of the present invention is to provide an apparatus and method for automatically controlling a RF PAM gain state directly related to a power consumption and a heat in a mobile communication system.

In accordance with an aspect of the present invention, a method for controlling a gain of RF PAM in a mobile communication system is provided. The method includes determining whether a temperature of the portable terminal is greater than a first threshold and whether a Received Signal Strength Indication (RSSI) of the portable terminal is greater than a second threshold under a specific condition and selectively adjusting the RF PAM gain to a predetermined state when the temperature is greater than the first threshold and when the RSSI is greater than the second threshold.

In accordance with an aspect of the present invention, an apparatus for controlling gain of a RF PAM in a mobile device is provided. The apparatus includes a modem for communicating with other nodes and having a thermister which determines a temperature and a controller for determining whether the temperature of the portable terminal is greater than a first threshold and whether a RSSI of the mobile device is greater than a second threshold under a specific condition and for selectively adjusting the RF PAM gain to a predetermined state when the first temperature of the mobile device is greater than the first threshold and when the RSSI is greater than the second threshold.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 illustrates a flowchart for an operation procedure of a portable terminal according to an exemplary embodiment of the present invention; and,

FIG. 2 illustrates a block diagram of a portable terminal according to an exemplary embodiment of the present invention.

### DETAILED DESCRIPTION OF THE INVENTION

Exemplary embodiments of the present invention will be described below with reference to the accompanying drawings. For the purposes simplicity and clarity, well-known functions or constructions are not described in detail as they would obscure the invention in unnecessary detail.

Hereinafter, an apparatus and a method for a RF PAM gain state control in a mobile communication system will be described.

A thermister in a portable terminal provides a current temperature to a controller. A thermister typically provides about 150 codes at a room temperature, about 210 codes at 60 degrees or provides about 70 codes at −30 degrees by digitalizing a sensed value.

When a user records a video or executes an application such as a video player using the portable terminal, the temperature of the portable terminal is increased due to continuous operations of corresponding parts of the portable terminal such as a controller chip or a codec chip. Under this condition, when a Radio Frequency Power Amplifier Module (RF PAM) is configured for a high gain, a power consumption of the portable terminal or the temperature of the portable terminal increases radically, especially when only a RSSI is considered in adjusting the gain output of the RF PAM.

Thus, when the user records the video or executes the application such as the video player using the portable terminal the teachings of the present invention prevents an increase in power consumption and temperature of the portable terminal.

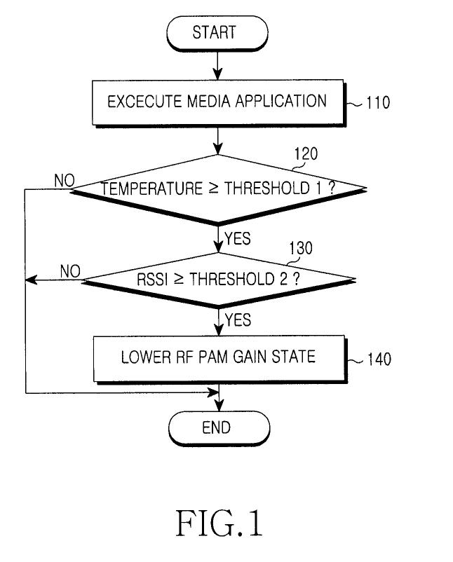

FIG. 1 illustrates a flowchart for an operation process of a portable terminal according to an exemplary embodiment of the present invention.

Referring FIG. 1, it is assumed that the portable terminal is executing a media application such as a recording application or a playing application in step 110.

During the media application mode, when the detected temperature is greater than or equal to a threshold 1 in step 120 and when the detected RSSI is greater than or equal to a threshold 2 in step 130, the portable terminal lowers a RF PAM gain state (i.e., to mid state or to low state) in step 140. That is, the supply voltage to the RF power amplifier is controlled based on the comparison result. Note that the threshold 1 and the threshold 2 may be determined by experiments and/or simulations by manufacturer or service operators.

The RF PAM gain state can be controlled based on various implementations. For example, the RF PAM gain state can be controlled by adjusting a bias voltage or current and the amount of the voltage or the current can be determined using a reference table or predetermined and the threshold 1 is a temperature threshold and the threshold 2 is a RSSI threshold for determining the RF PAM gain state.

When the temperature is less than the threshold 1 in step 120 or when the RSSI is less than the threshold 2 in step 130, the portable terminal maintains current RF PAM gain state and finishes algorithm.

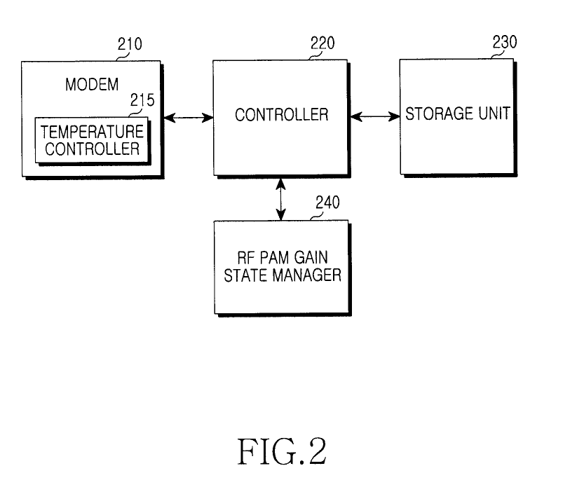

FIG. 2 illustrates a block diagram of a portable terminal according to an exemplary embodiment of the present invention.

Referring to FIG. 2, the portable terminal comprises a modem 210, a controller 220, a storage unit 230 and a RF PAM gain state manager 240.

The modem 210 is a module for performing communication with another node, and includes a radio processor and a base-band processor. The radio processor converts a signal received through an antenna into a base-band signal and provides the base-band signal to the base-band processor. Further, the radio processor converts the base-band signal received from the base-band processor into a radio signal so that the received signal can be transmitted through a wireless path, and then transmits the radio signal through the antenna. Especially, the modem 210 further comprises a temperature controller 215 which determines a temperature of the portable terminal and reports it to the RF PAM gain state manager 240. Basically, the modem 210 determines the RSSI when receiving signals. That is, a receiving function is integrated in the modem 210.

The controller 220 controls an overall operation of the portable terminal. In particular, the controller 220 controls the RF PAM gain state manager 240 according to the present invention.

The storage unit 230 performs a function of storing a program for controlling the overall operation of the portable terminal and for storing temporary data generated in the process of executing the program.

When the portable terminal is executing a media application, the RF PAM gain state manager 240 lowers a RF PAM gain state (i.e., to mid state or to low state) when a temperature is greater than or equal to a threshold 1 and when a RSSI is greater than or equal to a threshold 2.

The controller 220 and the RF PAM gain state manager 240 are separately illustrated to distinguish their functions. In an alternate embodiment, the controller 220 may process all or part of the functions of the RF PAM gain state manager 240. Thus, the controller 220 may serve as the RF PAM gain state manager 240.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the present invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the scope of the invention is defined not by the detailed description of the invention but by the appended claims and their equivalents, and all differences within the scope will be construed as being included in the present invention.

What is claimed is:

1. A method for controlling a gain of a Radio Frequency Power Amplifier Module (RF PAM) of a mobile communication system, the method comprising:
determining, by a controller, whether a temperature of the portable terminal is greater than a first threshold and whether a Received Signal Strength Indication (RSSI) of the portable terminal is greater than a second threshold under a specific condition; and
selectively adjusting, by the controller, the RF PAM gain to a predetermined state when the temperature is greater than the first threshold and when the RSSI is greater than the second threshold.

2. The method of claim 1, wherein the specific condition is when a media player is operating.

3. The method of claim 2, wherein the predetermined state indicates a lower state.

4. An apparatus for controlling a gain of a Radio Frequency Power Amplifier Module (RF PAM) of a mobile device, the apparatus comprising:
a modem for communicating with other nodes and having a thermister for determining a temperature of the mobile device; and,
a controller for determining whether the temperature is greater than a first threshold and whether a Received Signal Strength Indication (RSSI) of the mobile device is greater than a second threshold under a specific condition and for selectively adjusting the RF PAM gain to a predetermined state when the temperature of the mobile device is greater than the first threshold and when the RSSI is greater than the second threshold.

5. The apparatus of claim 4, wherein the specific condition is when a media player is running.

6. The apparatus of claim 4, wherein the specific state indicates a lower state.
